(19) United States
(12) Patent Application Publication
(10) Pub. No.: US 2018/0335011 A1
(43) Pub. Date: Nov. 22, 2018

(54) SUBMERGED TIDAL ENERGY POD

(71) Applicant: Nofel Izz, Mississauga (CA)

(72) Inventor: Nofel Izz, Mississauga (CA)

(21) Appl. No.: 15/598,482

(22) Filed: May 18, 2017

(51) Int. Cl. F03B 13/10; F03B 13/26

(52) U.S. Cl. CPC F03B 13/10; F03B 13/264

(57) ABSTRACT

Disclosed is a submerged tidal energy pod. The submerged tidal energy pod for harnessing tidal kinetic energy through ebbing and surging of tidal currents to produce electrical energy, the submerged tidal energy pod includes a turbine adapted for producing electrical energy using harnessed tidal kinetic energy through multiple aerodynamic and unidirectional water-flow designed blades regardless of ebb and flow of water currents, rotatable and perpendicularly connected with the turbine using corresponding blade arms.

### FIELD OF THE INVENTION

The present application generally relates to the field of energy production. Particularly, the application provides a submerged tidal energy pod. More particularly, the application provides a submerged tidal energy pod for harnessing tidal kinetic energy through ebbing and surging of tidal currents to produce electrical energy.

### BACKGROUND

Past decades have witnessed tremendous industrial growth and development. In turn energy consumption has also increased by several quanta. The industrial growth have certainly improved human life by several folds, however, at the same time it has also demonstrated severe consequences, such as higher consumption of fossil fuel resulting in high carbon dioxide emissions directly contributing in global warming.

There have been several efforts to develop and utilize alternative energy sources. Example of such alternative energy sources could be marine energy, tidal energy, hydroelectric, wind, geothermal and solar power and alike. Amongst others, tidal energy is one of the promising and sustainable alternative energy source which is seeking continuous attention from energy consumers.

Prior art illustrates development of various tools, techniques, methods for harnessing tidal energy. Prior art discloses tidal energy production through the use of tidal energy generators, wherein turbines are placed underwater with tidal movements for harnessing water currents to produce electricity. Some of the existing tools, systems related to tidal energy production known to us are as follows:

U.S. Pat. No. 7,471,009B2 to Clean Current LP discloses underwater ducted turbine. Particularly, the U.S. Pat. No. 7,471,009B2 discloses an apparatus for a turbine for generating electrical power from water or air flow comprising at least one rotor disk having a plurality of hydrofoil blades, guide vanes, a cylindrical housing, and a generator means.

U.S. Pat. No. 7,378,750B2 to OpenHydro Group Ltd discloses tidal flow hydroelectric turbine. Particularly, the U.S. Pat. No. 7,378,750B2 discloses a hydroelectric turbine for the production of electricity from tidal flow forces, the turbine having a rotor preferably with an open center such that the blades are mounted between an inner rim and outer rim, wherein retaining members and anti-friction members are provided to limit movement of the rotor relative to the housing in either axial direction.

U.S. Pat. No. 5,451,137A to Northeastern University discloses unidirectional helical reaction turbine operable under reversible fluid flow for power systems. Particularly, the U.S. Pat. No. 5,451,137A discloses a reaction turbine capable of providing high speed unidirectional rotation under a reversible ultra low head pressure and/or high velocity fluid flow, wherein the turbine comprises a working wheel with a plurality of airfoil-shaped blades mounted transversely to the direction of fluid flow for rotation in a plane parallel to the fluid flow. The blades are arranged in a helical configuration, a modification of a delta turbine, which ensures that a portion of the blades are always positioned perpendicular to the fluid pressure, thereby creating maximum thrust to spin the turbine and ensuring a continuous speed of rotation.

U.S. Pat. No. 7,331,762B2 to Marine Current Turbines Ltd discloses submerged water current turbines installed on a deck. Particularly, the U.S. Pat. No. 7,331,762B2 discloses a support structure for a flowing-water drivable turbine system having a pair of generally horizontal decks of streamlined cross-section and at least one turbine assembly mounted thereon for operational co-operation with a flow of water in which the decks and turbine assembly is submerged.

Prior art literature illustrates a variety of solution for harnessing tidal energy. However, the existing tools and systems described in the prior art fails to disclose tidal energy production efficiently per space unit. Prior art also fails to disclose efficiently designed tidal energy production tools and systems that does not impact marine life and ecosystem surrounding the tidal energy production systems.

In view of the above mentioned background, it is evident that, there is a need for a submerged tidal energy pod, which could efficiently harness tidal kinetic energy per space unit through ebbing and surging of tidal currents to produce electrical energy. There is a need for efficiently designed submerged tidal energy pod, which does not impact marine life and ecosystem while harnessing tidal kinetic energy to produce electrical energy. There is a need for submerged tidal energy pod, which could be attached or detached with other submerged tidal energy pods through an interlocking mechanism to create a network of submerged tidal energy pods for cost effective energy production. A submerged tidal energy pod is desired.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide a submerged tidal energy pod.

Another objective is to provide a submerged tidal energy podwhich could efficiently harness tidal kinetic energy per space unit through ebbing and surging of tidal currents to produce electrical energy.

Another objective is to provide an efficiently designed submerged tidal energy pod, which does not impact marine life and ecosystem while harnessing tidal kinetic energy to produce electrical energy.

Another objective is to provide a submerged tidal energy pod, which could be attached or detached with other submerged tidal energy pods through an interlocking mechanism to create a network of submerged tidal energy pods for cost effective energy production.

In accordance with one embodiment of the present invention, a submerged tidal energy pod(100) for harnessing tidal kinetic energy through ebbing and surging of tidal currents to produce electrical energy is provided. The submerged tidal energy pod (100) for harnessing tidal kinetic energy through ebbing and surging of tidal currents to produce electrical energy comprises of a turbine (102) adapted for producing electrical energy using harnessed tidal kinetic energy through a plurality of aerodynamic and unidirectional water-flow designed blades (104) regardless of ebb and flow of water currents, rotatable and perpendicularly connected with the turbine (102) using corresponding plurality of blade arms (106).

In accordance with one embodiment of the present invention, the turbine (102) further comprises of a rotor (110) rotatable and perpendicularly connected with the plurality of aerodynamic and unidirectional water-flow designed blades (104) using corresponding plurality of blade arms (106); a three stage planetary gear-box (112) rotatable connected to the rotor (110) and adapted for producing high gear ratios to produce electrical energy based on the harnessed tidal kinetic energy; and a generator (114) rotatable connected with the three stage planetary gear-box (112) for producing electrical energy.

In accordance with one embodiment of the present invention, the three stage planetary gear-box (112) further comprises of a low speed shaft (116) connected to the rotor (110); a high speed shaft (118) connected to the generator (114); a plurality of sun gears (120); a plurality of ring gear (122); a plurality of planetary gears (124) connected with each other using a plurality of planetary arms (126) in between; a spur gear (128); and an output gear (130).

In accordance with one embodiment of the present invention, the plurality of aerodynamic and unidirectional water-flow designed blades (104) further comprises of a blade body (132) constituting frame of the plurality of aerodynamic and unidirectional water-flow designed blades (104); a plurality of mini airfoils (134) extruding from the blade body (132) allowing to spit water as water-flow passes the blade body (132); and a blade bracket holder (136) adapted for holding and connecting the plurality of aerodynamic and unidirectional water-flow designed blades (104) to the rotor (110). The plurality of aerodynamic water-flow designed blades (104) is unidirectional regardless of ebb and flow of water currents.

The above invention is provided for a submerged tidal energy pod for harnessing tidal kinetic energy through ebbing and surging of tidal currents to produce electrical energy but also can be used for many other applications.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1: illustrates a perspective view of a submerged tidal energy pod, in accordance with one embodiment of the present invention;

FIG. 2: illustrates an upper view of a submerged tidal energy pod, in accordance with one embodiment of the present invention;

FIG. 3: illustrates a lower vide of a submerged tidal energy pod, in accordance with one embodiment of the present invention;

FIG. 4: illustrates a lower view of a turbine, in accordance with one embodiment of the present invention;

FIG. 5: illustrates an upper view of a turbine, in accordance with one embodiment of the present invention;

FIG. 6: illustrates an exploded view of a gear-box, in accordance with one embodiment of the present invention;

FIG. 7: illustrates a right view of a blade, in accordance with one embodiment of the present invention;

FIG. 8: illustrates a left view of a blade, in accordance with one embodiment of the present invention;

FIG. 9: illustrates a top view of a blade, in accordance with one embodiment of the present invention;

FIG. 10: illustrates a right exploded view of a blade, in accordance with one embodiment of the present invention;

FIG. 11: illustrates a left exploded view of a blade, in accordance with one embodiment of the present invention;

FIG. 12: illustrates a top exploded view of a blade, in accordance with one embodiment of the present invention;

FIG. 13: illustrates a right exploded view of a blade with water flow direction, in accordance with one embodiment of the present invention;

FIG. 14: illustrates a left exploded view of a blade with water flow direction, in accordance with one embodiment of the present invention;

FIG. 15: illustrates a top exploded view of a blade with water flow direction, in accordance with one embodiment of the present invention;

FIG. 16: illustrates a P-v graph, in accordance with one embodiment of the present invention;

FIG. 17: illustrates a perspective view of a plurality of submerged tidal energy pod, in accordance with one embodiment of the present invention;

FIG. 18: illustrates a perspective view of a network of a plurality of submerged tidal energy pod, in accordance with one embodiment of the present invention; and

FIG. 19: illustrates a perspective view of a network of a plurality of submerged tidal energy pod on ocean floor, in accordance with one embodiment of the present invention.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

In accordance with one embodiment of the present invention, a submerged tidal energy pod(100) for harnessing tidal kinetic energy through ebbing and surging of tidal currents to produce electrical energy is provided. The submerged tidal energy pod(100) is provided, which could efficiently harness tidal kinetic energy per space unit through ebbing and surging of tidal currents to produce electrical energy. The efficiently designed submerged tidal energy pod (100) is provided, which does not impact marine life and ecosystem while harnessing tidal kinetic energy to produce electrical energy. The submerged tidal energy pod (100) is provided, which could be attached or detached with other submerged tidal energy pods through an interlocking mechanism to create a network of submerged tidal energy pods for cost effective energy production.

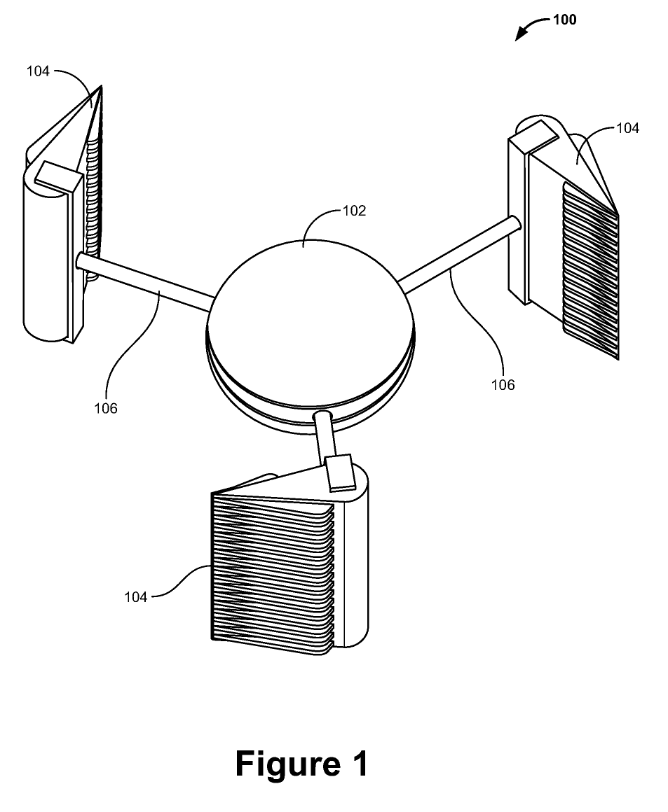

Referring to the FIG. 1 that illustrates a perspective view of a submerged tidal energy pod, in accordance with one embodiment of the present invention.

In accordance with one embodiment of the present invention, the submerged tidal energy pod(100) for harnessing tidal kinetic energy through ebbing and surging of tidal currents to produce electrical energy comprises of a turbine (102), a plurality of aerodynamic and unidirectional water-flow designed blades (104), and a corresponding plurality of blade arms (106). The turbine (102) may be adapted for producing electrical energy using harnessed tidal kinetic energy through the plurality of aerodynamic and unidirectional water-flow designed blades (104). The plurality of aerodynamic and unidirectional water-flow designed blades (104) may be rotatable and perpendicularly connected with the turbine (102) using corresponding plurality of blade arms (106). The plurality of aerodynamic water-flow designed blades (104) may be unidirectional regardless of ebb and flow of water currents.

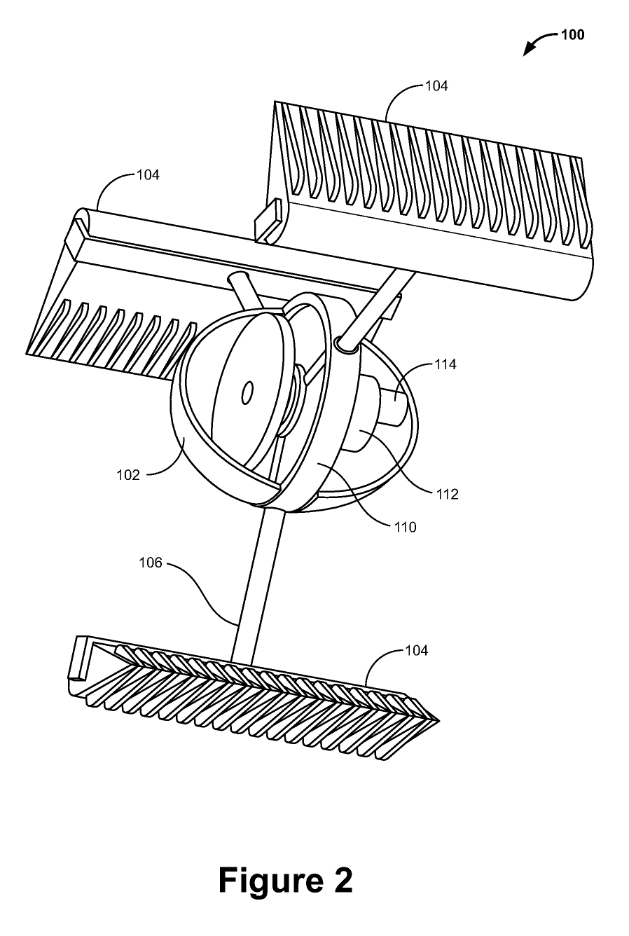

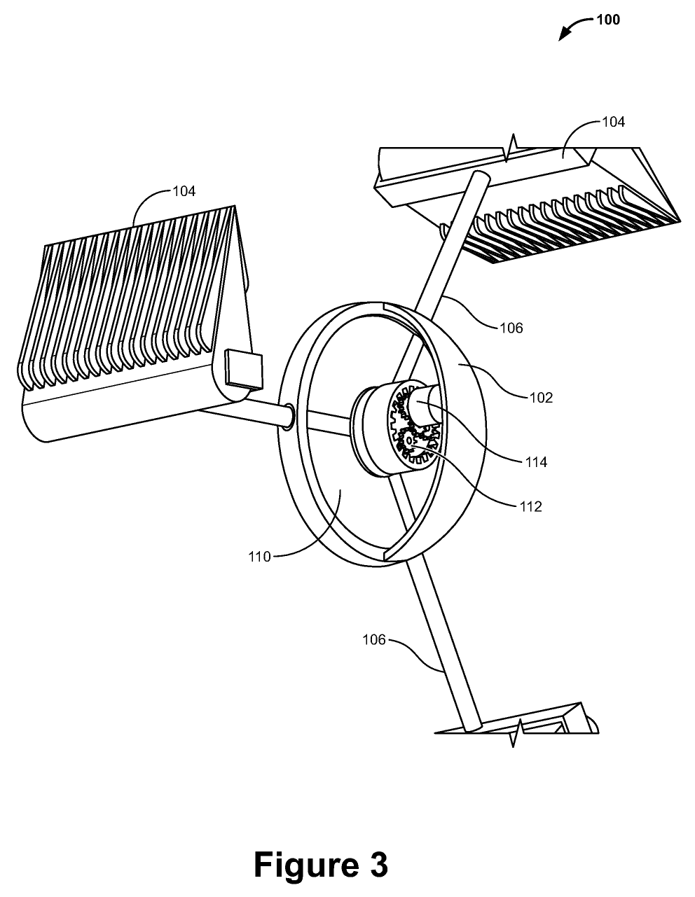

Referring to the FIG. 2 and FIG. 3 that illustrates an upper and lower view of a submerged tidal energy pod, in accordance with one embodiment of the present invention.

In accordance with one embodiment of the present invention, the turbine (102) may further comprise of a rotor (110); a three stage planetary gear-box (112), and a generator (114). The rotor (110) may be rotatable and perpendicularly connected with the plurality of aerodynamic and unidirectional water-flow designed blades (104) using the corresponding plurality of blade arms (106). The three stage planetary gear-box (112) may be rotatable connected to the rotor (110) and adapted for producing high gear ratios to produce electrical energy based on the harnessed tidal kinetic energy. The generator (114) may be rotatable connected with the three stage planetary gear-box (112) for producing electrical energy.

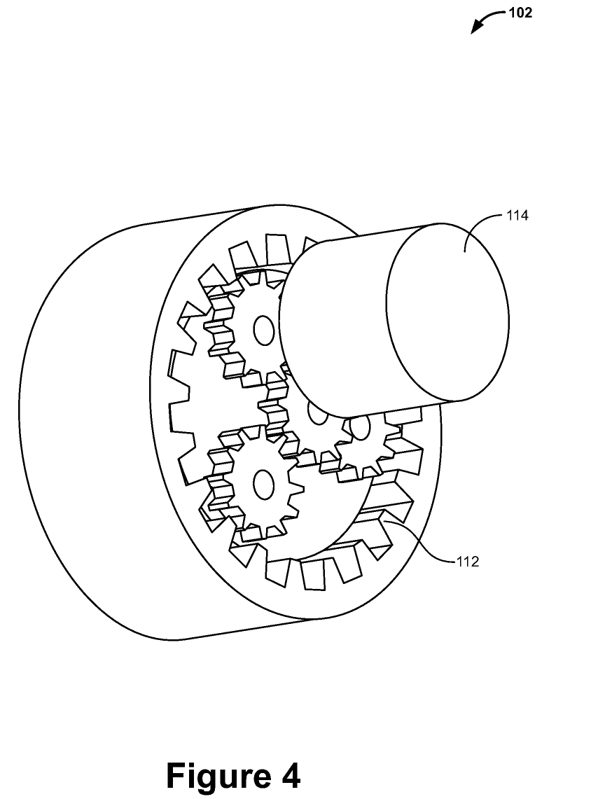

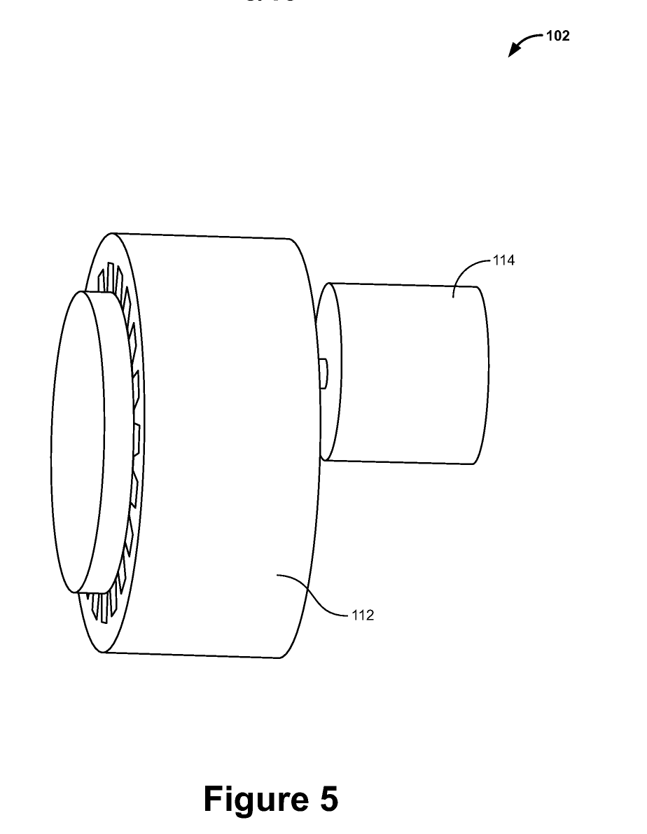

Referring to the FIG. 4 and FIG. 5 that illustrates a lower and upper view of a turbine, in accordance with one embodiment of the present invention.

In accordance with one embodiment of the present invention, the turbine (102) may further comprise of the three stage planetary gear-box (112), and the generator (114). The three stage planetary gear-box (112) may be rotatable connected to the rotor (110) and adapted for producing high gear ratios to produce electrical energy based on the harnessed tidal kinetic energy. The generator (114) may be rotatable connected with the three stage planetary gear-box (112) for producing electrical energy.

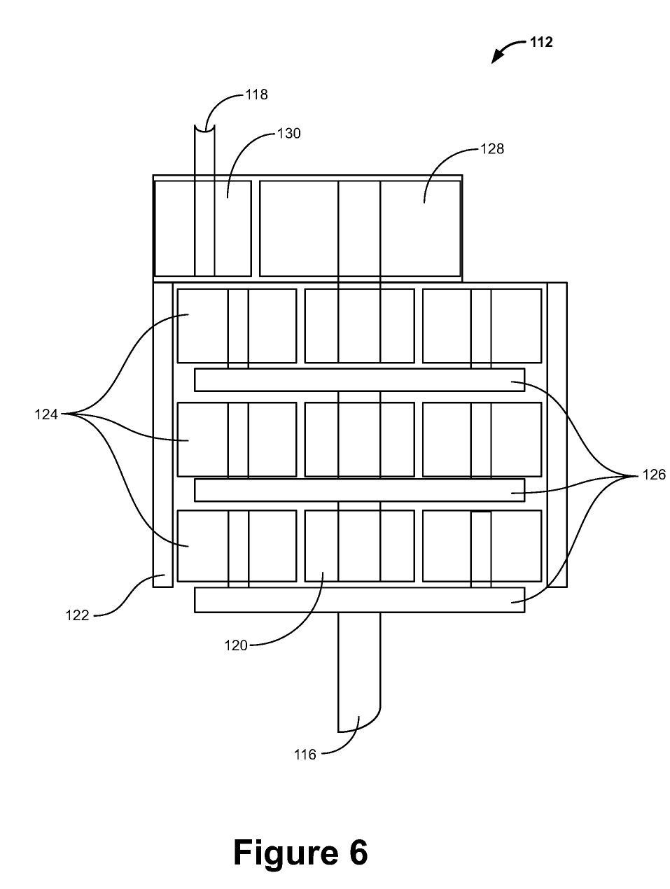

Referring to the FIG. 6 that illustrates an exploded view of a gear-box, in accordance with one embodiment of the present invention.

In accordance with one embodiment of the present invention, the three stage planetary gear-box (112) further comprises of a low speed shaft (116) connected to the rotor (110), a high speed shaft (118) connected to the generator (114), a plurality of sun gears (120), a plurality of ring gear (122), a plurality of planetary gears (124) connected with each other using a plurality of planetary arms (126) in between, a spur gear (128), and an output gear (130).

In accordance with one embodiment of the present invention, the three stage planetary gear-box (112) may be rotatable connected to the rotor (110) and adapted for producing high gear ratios to produce electrical energy based on the harnessed tidal kinetic energy. The following formula may be used to calculate gear ratio:

General formula for gear ratio:

(R+S)Ty=(R×Tr)+(Ts×S)

Where:

R=Number of Teeth in Ring gear

S=Number of Teeth in Sun gear

Ty=Turns of the planetary gear carrier

Tr=Turns of Ring gear

Ts=Turns of Sun gear

The three stage planetary gear-box (112) may have a stationary ring gear. So the formula will be:

Tr=Zero due to Ring gear was stationary

(R+S)Ty=(R×Tr)+(Ts×S)

(R+S)Ty=(R×Tr)+(Ts×S)

(R+S)Ty=(Ts×S)

The input may be the planetary carrier (124) and the output may be the sun gear (120).

Gear ratio=Output gear/Input gear

Gear ratio=Ts/Ty=(R+S)/S

In the 1st to 3rd planetary gear (124), the number of teeth of the sun gear (120), the planetary gear (124) and the ring gear (122) are the same.

R=75

S=25

P=(R+S)/2

P=50

Therefore:

$$Gear ratio = Ts / Ty = ( R + S ) / S$$

$$Ts / Ty = ( R + S ) / S = ( 75 + 25 ) / 25$$

$$Gear ratio = 4 ( 1 st to 3 rd stage planetary gear ( 124 ) )$$

For the 4th stage: spur gear (128) combination

$$Spur input \text{gear} = 25 teeth$$

$$Spur output gear = 75 teeth$$

$$\begin{matrix}Gear ratio = Output gear / Input gear \\ = 75 / 25\end{matrix}$$

$$Gear ratio = 3$$

Therefore, the overall gear ratio of 3 stage planetary gear and spur gear will be:

Overall gear ratio=(1st stage gear ratio)(2nd stage gear ratio)(3rd stage gear ratio)(4th stage gear ratio)=(4)(4)(4)(3)

Combined gear ratio=192

Overall gear ratio=192:1

Means: 1 rotation of the rotor will create 192 rotations on the gear of the generator

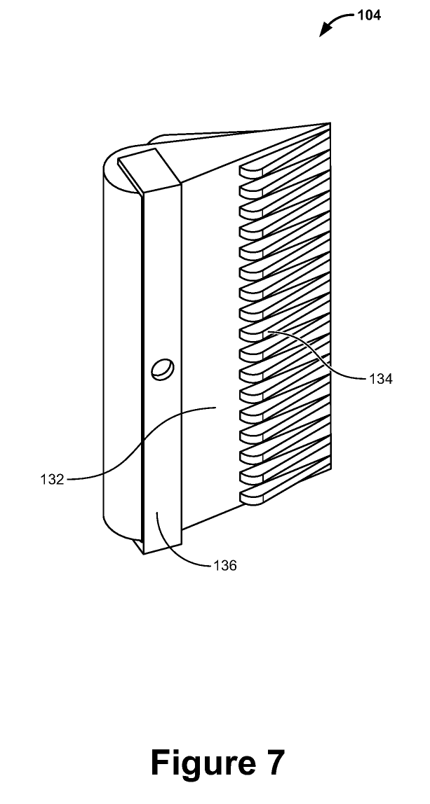

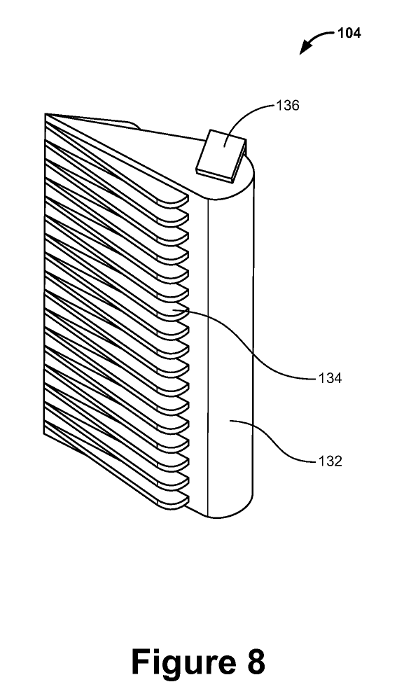

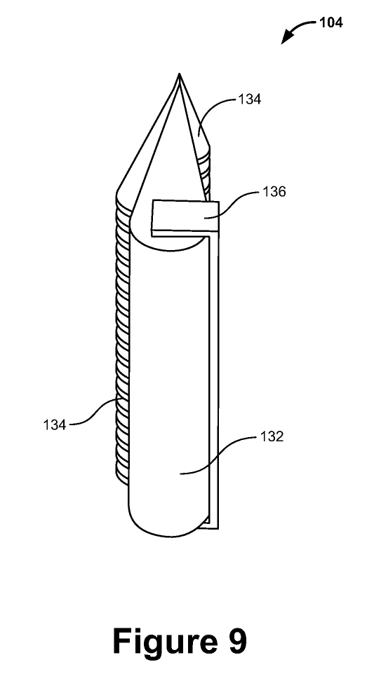

Referring to the FIG. 7, FIG. 8, and FIG. 9 are illustrating a right, left, and top view of a blade respectively, in accordance with one embodiment of the present invention.

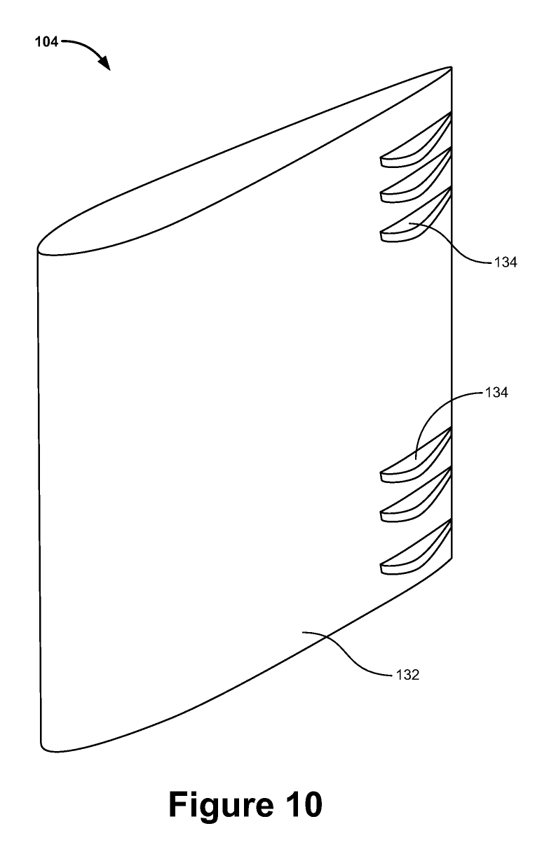

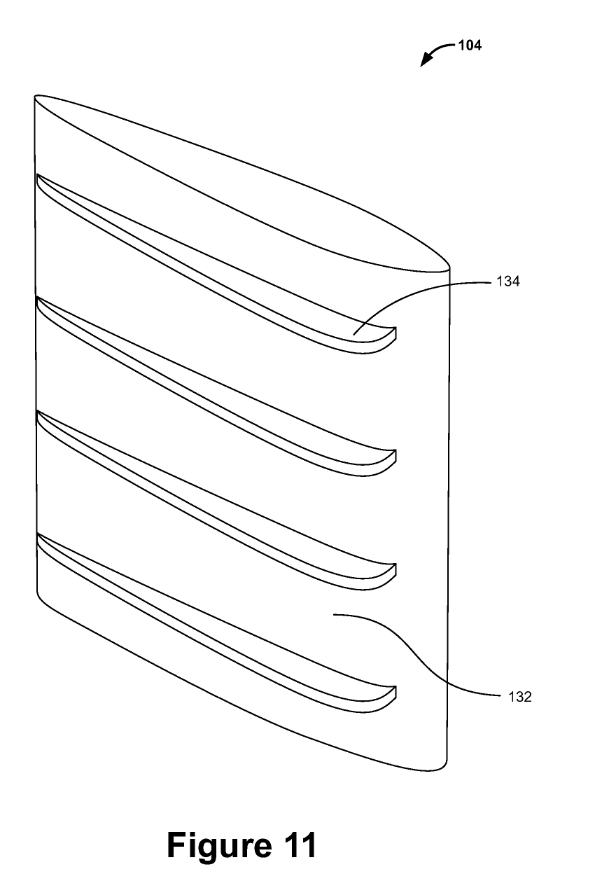

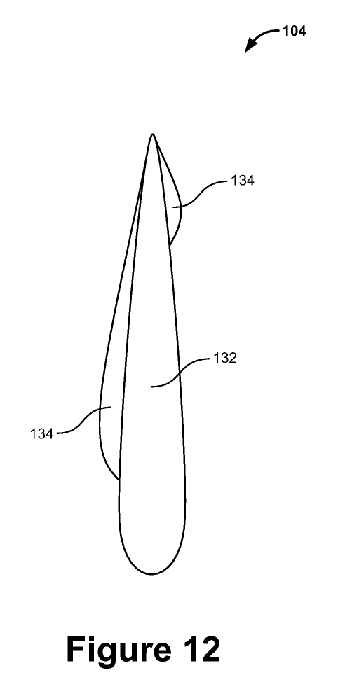

Referring to the FIG. 10, FIG. 11 and FIG. 12 are illustrating a right, left, and top exploded view of a blade, in accordance with one embodiment of the present invention.

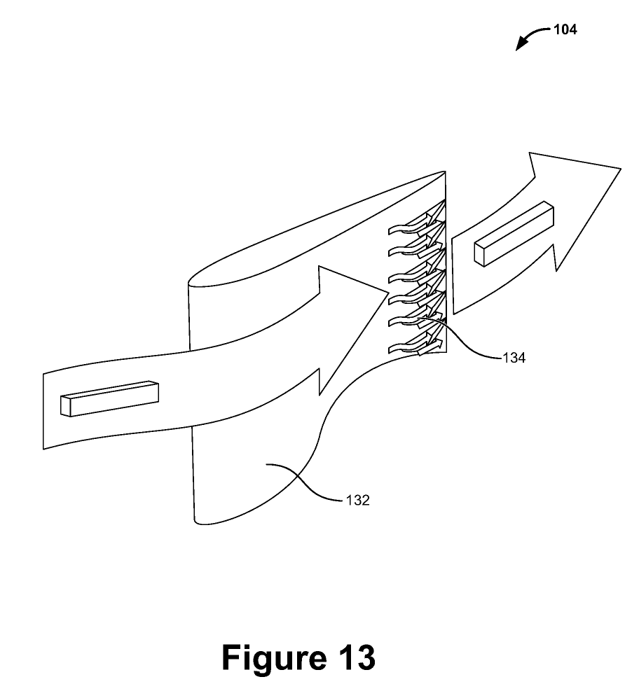

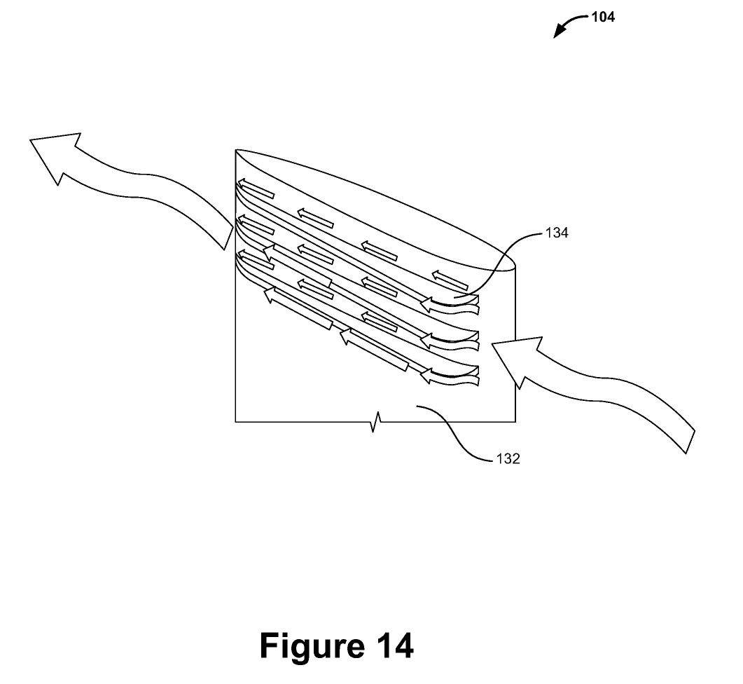

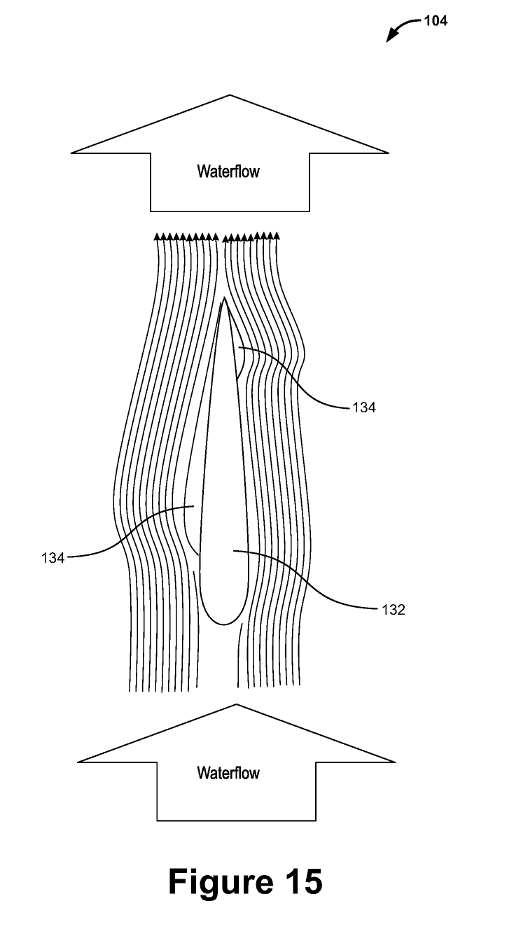

Referring to the FIG. 13, FIG. 14, and FIG. 15 are illustrating a right, left, and top exploded view of a blade with water flow direction, in accordance with one embodiment of the present invention.

In accordance with one embodiment of the present invention, the plurality of aerodynamic and unidirectional water-flow designed blades (104) further comprises of a blade body (132), a plurality of mini airfoils (134), and a blade bracket holder (136). The plurality of aerodynamic water-flow designed blades (104) may be unidirectional regardless of ebb and flow of water currents. The blade body (132) may constitute frame of the plurality of aerodynamic and unidirectional water-flow designed blades (104). The plurality of mini airfoils (134) may extrude from the blade body (132) allowing spitting water as water-flow passes the blade body (132). The plurality of mini airfoils (134) extruding from the blade body (132) may increase lift and reduce drag force for rotation of the plurality of aerodynamic and unidirectional water-flow designed blades (104). The plurality of mini airfoils (134) extruding from the blade body (132) may make spinning movement of the plurality of aerodynamic and unidirectional water-flow designed blades (104) more efficient. The blade bracket holder (136) may be adapted for holding and connecting the plurality of aerodynamic and unidirectional water-flow designed blades (104) to the rotor (110).

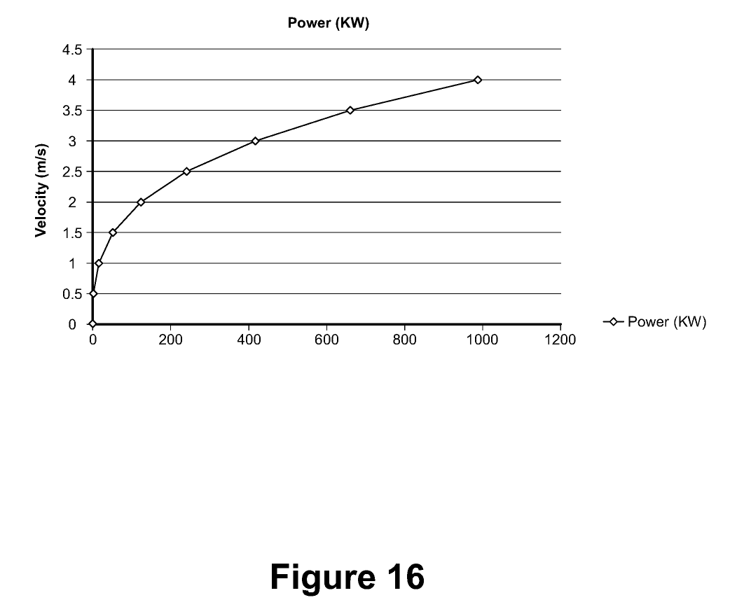

Referring to the FIG. 16 is illustrating a P-v graph, in accordance with one embodiment of the present invention.

In accordance with an exemplary embodiment of the present invention, the calculation for energy or power generated using the submerged tidal energy pod(100) may be based on the following formula:

P=½ρAv̂3

Where:

P=Power/Energy generated by the turbine

ρ=Density of Sea water(1029 kg/m̂3)

A=Swept Area; for VAWT (DXH)

D=Diameter of the rotor(5 meters)

H=Height of the Blade(6 meters)

V=velocity of the water flow

Swept Area will be, A=30 m̂2

If velocity is 0.5 m/s, Power will be.

$$\begin{matrix}Formula \text{:} P =. ρ {Av}^{⋀} 3 & \\ \begin{matrix}P = . ρ {Av}^{⋀} 3 \\ = . ( 1029 kg \text{/} {m}^{⋀} 3 ) ( 30 {m}^{⋀} 2 ) {( 0.5 m \text{/} s )}^{⋀} 3 \\ = . ( 1029 kg \text{/} {m}^{⋀} 3 ) ( 30 {m}^{⋀} 2 ) ( 0.125 {m}^{⋀} 3 \text{/} {s}^{⋀} 3 ) \\ = . ( 1029 kg \text{/} {m}^{⋀} 3 ) ( 30 {m}^{⋀} 2 ) ( 0.125 {m}^{⋀} 3 \text{/} {s}^{⋀} 3 ) \\ = 1 , 929.375 kg . {m}^{⋀} 2 \text{/} {s}^{⋀} 3 \\ = 1 , 929.375 ( kg . m \text{/} {s}^{⋀} 2 ) ( m \text{/} s ) \\ = 1 , 929.375 ( N ) ( m \text{/} s ) \\ = 1 , 929.375 W ( 1 kW / 1000 W ) \\ = 1.93 kW\end{matrix} & \\ Note \text{:} kg . m \text{/} {s}^{⋀} 2 = N ( Newton ) \\ N . m \text{/} s = W ( WaQs ) \\ 1000 W = 1 kW & \end{matrix}$$

If velocity is 1 m/s, Power will be.

$$\begin{matrix}Formula \text{:} P =. ρ {Av}^{⋀} 3 & \\ \begin{matrix}P = . ρ {Av}^{⋀} 3 \\ = . ( 1029 kg \text{/} {m}^{⋀} 3 ) ( 30 {m}^{⋀} 2 ) {( 1 m \text{/} s )}^{⋀} 3 \\ = . ( 1029 kg \text{/} {m}^{⋀} 3 ) ( 30 {m}^{⋀} 2 ) ( 1 {m}^{⋀} 3 \text{/} {s}^{⋀} 3 ) \\ = . ( 1029 kg \text{/} {m}^{⋀} 3 ) ( 30 {m}^{⋀} 2 ) ( 1 {m}^{⋀} 3 \text{/} {s}^{⋀} 3 ) \\ = 15 , 435 kg . {m}^{⋀} 2 \text{/} {s}^{⋀} 3 \\ = 15 , 435 ( kg . m \text{/} {s}^{⋀} 2 ) ( m \text{/} s ) \\ = 15 , 435 ( N ) ( m \text{/} s ) \\ = 15 , 435 W ( 1 kW / 1000 W ) \\ = 15.44 kW\end{matrix} & \\ Note \text{:} kg . m \text{/} {s}^{⋀} 2 = N ( Newton ) \\ N . m \text{/} s = W ( WaQs ) \\ 1000 W = 1 kW & \end{matrix}$$

If velocity is 1.5 m/s, Power will be.

$$\begin{matrix}Formula \text{:} P =. ρ {Av}^{⋀} 3 & \\ \begin{matrix}P = . ρ {Av}^{⋀} 3 \\ = . ( 1029 kg \text{/} {m}^{⋀} 3 ) ( 30 {m}^{⋀} 2 ) {( 1.5 m \text{/} s )}^{⋀} 3 \\ = . ( 1029 kg \text{/} {m}^{⋀} 3 ) ( 30 {m}^{⋀} 2 ) ( 3.375 {m}^{⋀} 3 \text{/} {s}^{⋀} 3 ) \\ = . ( 1029 kg \text{/} {m}^{⋀} 3 ) ( 30 {m}^{⋀} 2 ) ( 3.375 {m}^{⋀} 3 \text{/} {s}^{⋀} 3 ) \\ = 52 , 093.125 kg . {m}^{⋀} 2 \text{/} {s}^{⋀} 3 \\ = 52 , 093.125 ( kg . m \text{/} {s}^{⋀} 2 ) ( m \text{/} s ) \\ = 52 , 09 \; 3.125 ( N ) ( m \text{/} s ) \\ = 52 , 093.125 W ( 1 kW / 1000 W ) \\ = 52.09 kW\end{matrix} & \\ Note \text{:} kg . m \text{/} {s}^{⋀} 2 = N ( Newton ) \\ N . m \text{/} s = W ( WaQs ) \\ 1000 W = 1 kW & \end{matrix}$$

If velocity is 2 m/s, Power will be.

$$\begin{matrix}Formula \text{:} P =. ρ {Av}^{⋀} 3 & \\ \begin{matrix}P = . ρ {Av}^{⋀} 3 \\ = . ( 1029 kg \text{/} {m}^{⋀} 3 ) ( 30 {m}^{⋀} 2 ) {( 2 m \text{/} s )}^{⋀} 3 \\ = . ( 1029 kg \text{/} {m}^{⋀} 3 ) ( 30 {m}^{⋀} 2 ) ( 8 {m}^{⋀} 3 \text{/} {s}^{⋀} 3 ) \\ = . ( 1029 kg \text{/} {m}^{⋀} 3 ) ( 30 {m}^{⋀} 2 ) ( 8 {m}^{⋀} 3 \text{/} {s}^{⋀} 3 ) \\ = 123 , 480 kg . {m}^{⋀} 2 \text{/} {s}^{⋀} 3 \\ = 123 , 480 ( kg . m \text{/} {s}^{⋀} 2 ) ( m \text{/} s ) \\ = 123 , 480 ( N ) ( m \text{/} s ) \\ = 123 , 480 W ( 1 kW / 1000 W ) \\ = 123.48 kW\end{matrix} & \\ Note \text{:} kg . m \text{/} {s}^{⋀} 2 = N ( Newton ) \\ N . m \text{/} s = W ( WaQs ) \\ 1000 W = 1 kW & \end{matrix}$$

If velocity is 2.5 m/s, Power will be.

$$\begin{matrix}Formula \text{:} P =. ρ {Av}^{⋀} 3 & \\ \begin{matrix}P = . ρ {Av}^{⋀} 3 \\ = . ( 1029 kg \text{/} {m}^{⋀} 3 ) ( 30 {m}^{⋀} 2 ) {( 2 .5 m \text{/} s )}^{⋀} 3 \\ = . ( 1029 kg \text{/} {m}^{⋀} 3 ) ( 30 {m}^{⋀} 2 ) ( 15.625 {m}^{⋀} 3 \text{/} {s}^{⋀} 3 ) \\ = . ( 1029 kg \text{/} {m}^{⋀} 3 ) ( 30 {m}^{⋀} 2 ) ( 15.625 {m}^{⋀} 3 \text{/} {s}^{⋀} 3 ) \\ = 241 , 171.875 kg . {m}^{⋀} 2 \text{/} {s}^{⋀} 3 \\ = 241 , 171.875 ( kg . m \text{/} {s}^{⋀} 2 ) ( m \text{/} s ) \\ = 241 , 171.875 ( N ) ( m \text{/} s ) \\ = 241 , 171.865 W ( 1 kW / 1000 W ) \\ = 241.17 kW\end{matrix} & \\ Note \text{:} kg . m \text{/} {s}^{⋀} 2 = N ( Newton ) \\ N . m \text{/} s = W ( WaQs ) \\ 1000 W = 1 kW & \end{matrix}$$

If velocity is 3 m/s, Power will be.

$$\begin{matrix}Formula \text{:} P =. ρ {Av}^{⋀} 3 & \\ \begin{matrix}P = . ρ {Av}^{⋀} 3 \\ = . ( 1029 kg \text{/} {m}^{⋀} 3 ) ( 30 {m}^{⋀} 2 ) {( 3 m \text{/} s )}^{⋀} 3 \\ = . ( 1029 kg \text{/} {m}^{⋀} 3 ) ( 30 {m}^{⋀} 2 ) ( 27 {m}^{⋀} 3 \text{/} {s}^{⋀} 3 ) \\ = . ( 1029 kg \text{/} {m}^{⋀} 3 ) ( 30 {m}^{⋀} 2 ) ( 27 {m}^{⋀} 3 \text{/} {s}^{⋀} 3 ) \\ = 416 , 745 kg . {m}^{⋀} 2 \text{/} {s}^{⋀} 3 \\ = 416 , 745 ( kg . m \text{/} {s}^{⋀} 2 ) ( m \text{/} s ) \\ = 416 , 745 ( N ) ( m \text{/} s ) \\ = 416 , 745 W ( 1 kW \text{/} 1000 W ) \\ = 416.75 kW\end{matrix} & \\ Note \text{:} kg . m \text{/} {s}^{⋀} 2 = N ( Newton ) \\ N . m \text{/} s = W ( WaQs ) \\ 1000 W = 1 kW & \end{matrix}$$

If velocity is 3.5 m/s, Power will be.

$$\begin{matrix}Formula \text{:} P =. ρ {Av}^{⋀} 3 & \\ \begin{matrix}P = . ρ {Av}^{⋀} 3 \\ = . ( 1029 kg \text{/} {m}^{⋀} 3 ) ( 30 {m}^{⋀} 2 ) {( 3.5 m \text{/} s )}^{⋀} 3 \\ = . ( 1029 kg \text{/} {m}^{⋀} 3 ) ( 30 {m}^{⋀} 2 ) ( 42.875 {m}^{⋀} 3 \text{/} {s}^{⋀} 3 ) \\ = . ( 1029 kg \text{/} {m}^{⋀} 3 ) ( 30 {m}^{⋀} 2 ) ( 42.875 {m}^{⋀} 3 \text{/} {s}^{⋀} 3 ) \\ = 661 , 775.625 kg . {m}^{⋀} 2 \text{/} {s}^{⋀} 3 \\ = 661 , 775.625 ( kg . m \text{/} {s}^{⋀} 2 ) ( m \text{/} s ) \\ = 661 , 775.625 ( N ) ( m \text{/} s ) \\ = 661 , 775.625 W ( 1 kW / 1000 W ) \\ = 661.78 kW\end{matrix} & \\ Note \text{:} kg . m \text{/} {s}^{⋀} 2 = N ( Newton ) \\ N . m \text{/} s = W ( WaQs ) \\ 1000 W = 1 kW & \end{matrix}$$

If velocity is 4 m/s, Power will be.

$$\begin{matrix}Formula \text{:} P =. ρ {Av}^{⋀} 3 & \\ \begin{matrix}P = . ρ {Av}^{⋀} 3 \\ = . ( 1029 kg \text{/} {m}^{⋀} 3 ) ( 30 {m}^{⋀} 2 ) {( 4 m \text{/} s )}^{⋀} 3 \\ = . ( 1029 kg \text{/} {m}^{⋀} 3 ) ( 30 {m}^{⋀} 2 ) ( 64 {m}^{⋀} 3 \text{/} {s}^{⋀} 3 ) \\ = . ( 1029 kg \text{/} {m}^{⋀} 3 ) ( 30 {m}^{⋀} 2 ) ( 64 {m}^{⋀} 3 \text{/} {s}^{⋀} 3 ) \\ = 987 , 840 kg . {m}^{⋀} 2 \text{/} {s}^{⋀} 3 \\ = 987 , 840 ( kg . m \text{/} {s}^{⋀} 2 ) ( m \text{/} s ) \\ = 987 , 840 ( N ) ( m \text{/} s ) \\ = 987 , 840 W ( 1 kW / 1000 W ) \\ = 987.84 kW\end{matrix} & \\ Note \text{:} kg . m \text{/} {s}^{⋀} 2 = N ( Newton ) \\ N . m \text{/} s = W ( WaQs ) \\ 1000 W = 1 kW & \end{matrix}$$

In accordance with an exemplary embodiment of the present invention, based on the graph of power (KW) v/s velocity (m/s), the power generated by the turbine (102) was directly proportional to velocity and also to the swept area of the turbine (102). It should be noted that the computation was only for one turbine unit (102). Therefore, as the more number of the turbine (102) are added, the more power generation is achieved.

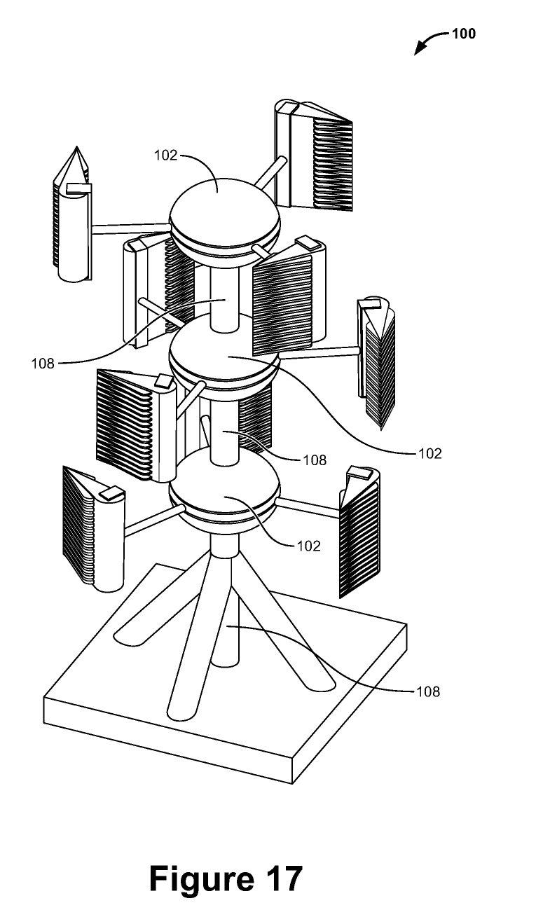

Referring to the FIG. 17 that illustrates a perspective view of a plurality of submerged tidal energy pod, in accordance with one embodiment of the present invention.

In accordance with one embodiment of the present invention, at least two of the submerged tidal energy pod (100) may be vertically connected with each other using a tower (108) to form a plurality of submerged tidal energy pod (100).

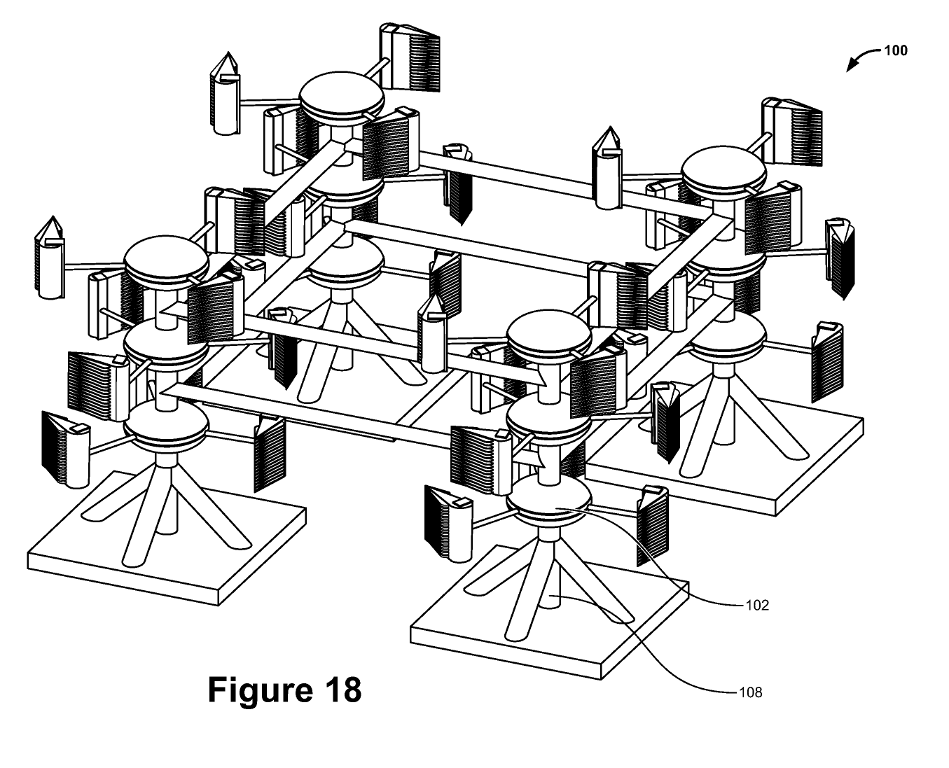

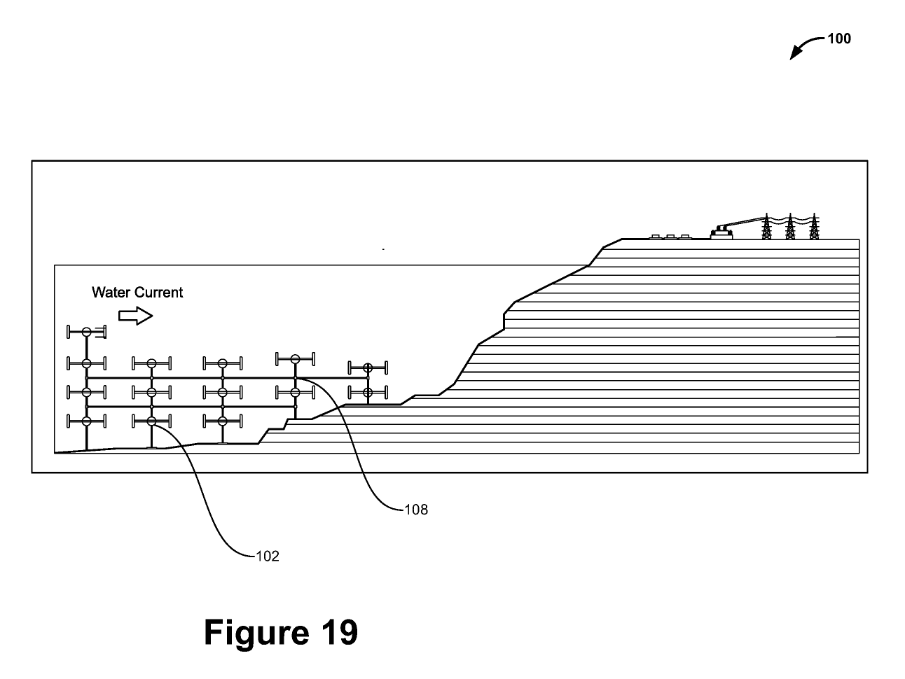

Referring to the FIG. 18, and FIG. 19 are illustrating a perspective view of a network of a plurality of submerged tidal energy pod and a plurality of submerged tidal energy pod on ocean floor, in accordance with one embodiment of the present invention.

In accordance with one embodiment of the present invention, at least two of the plurality of submerged tidal energy pod (100) may be horizontally connected with each other using the tower (108) to form a network of submerged tidal energy pod (100). The network of submerged tidal energy pod (100) may be placed on ocean floor. The electrical energy produced may be shared through each of the plurality of submerged tidal energy pod (100) that may be generating individual electrical energy on its own as a unit and all together when connected as shared electrical energy. The shared or individual electrical energy may also be connected to a transformer and transformer lines situated above ground level. Each of the plurality of submerged tidal energy pod (100) may be removable, attachable and designed for cost effective process that may only require attaching each of the plurality of submerged tidal energy pod (100) on top of each other so that an interlocking mechanism may activate each of the plurality of submerged tidal energy pod (100) being connected for electrical energy generation.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

What is claimed is:

1. A submerged tidal energy pod (100) for harnessing tidal kinetic energy through ebbing and surging of tidal currents to produce electrical energy; wherein the submerged tidal energy pod (100) comprises of a turbine (102) adapted for producing electrical energy using harnessed tidal kinetic energy through a plurality of aerodynamic and unidirectional water-flow designed blades (104) rotatable and perpendicularly connected with the turbine (102) using corresponding plurality of blade arms (106).

2. The submerged tidal energy pod (100) as claimed in claim 1, wherein the turbine (102) further comprises of a rotor (110) rotatable and perpendicularly connected with the plurality of aerodynamic and unidirectional water-flow designed blades (104) using corresponding plurality of blade arms (106); a three stage planetary gear-box (112) rotatable connected to the rotor (110) and adapted for producing high gear ratios to produce electrical energy based on the harnessed tidal kinetic energy; and a generator (114) rotatable connected with the three stage planetary gear-box (112) for producing electrical energy.

3. The submerged tidal energy pod (100) as claimed in claim 2, wherein the three stage planetary gear-box (112) further comprises of a low speed shaft (116) connected to the rotor (110); a high speed shaft (118) connected to the generator (114); a plurality of sun gears (120); a plurality of ring gear (122); a plurality of planetary gears (124) connected with each other using a plurality of planetary arms (126) in between; a spur gear (128); and an output gear (130).

4. The submerged tidal energy pod (100) as claimed in claim 1, wherein the plurality of aerodynamic and unidirectional water-flow designed blades (104) further comprises of a blade body (132) constituting frame of the plurality of aerodynamic and unidirectional water-flow designed blades (104); a plurality of mini airfoils (134) extruding from the blade body (132) allowing to spit water as water-flow passes the blade body (132); and a blade bracket holder (136) adapted for holding and connecting the plurality of aerodynamic and unidirectional water-flow designed blades (104) to the rotor (110).

5. The submerged tidal energy pod (100) as claimed in claim 4, wherein the plurality of mini airfoils (134) extruding from the blade body (132) increase lift and reduce drag force for rotation of the plurality of aerodynamic and unidirectional water-flow designed blades (104).

6. The submerged tidal energy pod (100) as claimed in claim 1, further comprises of a plurality of submerged tidal energy pod (100) wherein at least two of the submerged tidal energy pod (100) are vertically connected with each other using a tower (108).

7. The submerged tidal energy pod (100) as claimed in claim 1, further comprises of a network of submerged tidal energy pod (100) wherein at least two of the plurality of submerged tidal energy pod (100) are horizontally connected with each other using the tower (108).
